(19) United States
(12) Patent Application Publication
(10) Pub. No.: US 2021/0243248 A1
(43) Pub. Date: Aug. 5, 2021

(54) CLOUD SERVICE LOAD BALANCING

(71) Applicant: Tigera, Inc., San Francisco, CA (US)

(72) Inventors: Alexander James Pollitt, San Francisco, CA (US); Shaun Crampton, London (GB)

(21) Appl. No.: 16/779,112

(22) Filed: Jan. 31, 2020

(51) Int. Cl. H04L 29/08; H04L 12/741; H04L 29/12

(52) U.S. Cl. CPC H04L 67/1002; H04L 45/745; H04L 61/6022; H04L 61/2592; H04L 61/2007

(57) ABSTRACT

A data packet associated with a data request is analyzed at a load balancing node of a cloud service. The cloud service comprises a plurality of computing nodes. A computing node included in the plurality of computing nodes is selected to service the data request, based at least in part on a determination via from an analysis that the selected computing node is associated with a workload associated with the data request. The data packet associated with the data request is provided to the selected computing node. The computing node selects a workload from one or more workloads hosted by the computing node to handle the data request.

### BACKGROUND OF THE INVENTION

A cloud service is a service provided on a cloud-computing platform (e.g., Amazon Web Service, Microsoft Azure, Google Cloud, etc.) to users via the internet. The cloud service may be comprised of a plurality of workloads (e.g., virtual machines, containers, pods, etc.). The cloud-computing platform may provision a plurality of computing nodes for the cloud service. A user system may send a request to the cloud service. One of the computing nodes associated with the cloud service (e.g., a load balancing node) may receive the request and determine which computing node of the plurality of computing nodes that will service the request. The request may be provided to the determined computing node. A workload of the determined computing node may service the request and send a response. The response may be provided to the user system via the load balancing node. However, the cloud service may receive a large number of concurrent requests. As a result, the load balancing node may become a bottleneck for the cloud service.

### BRIEF DESCRIPTION OF THE DRAWINGS

Various embodiments of the invention are disclosed in the following detailed description and the accompanying drawings.

FIG. 1 is a block diagram illustrating an embodiment of a system for cloud service load balancing.

FIG. 2 is a block diagram illustrating an embodiment of a computing node.

FIG. 3 is a flow chart illustrating an embodiment of a process for cloud service load balancing.

FIG. 4 is a flow chart illustrating an embodiment of a process for analyzing a data packet.

FIG. 5 is a flow chart illustrating an embodiment of a process for cloud service load balancing.

FIG. 6 is a flow chart illustrating an embodiment of a process for responding to a cloud service request.

FIG. 7 is a flow chart illustrating an embodiment of a process for responding to a cloud service request.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Direct server return (DSR) or other techniques may be implemented by a cloud service to reduce the load on a load balancing node associated with the cloud service. Techniques are disclosed to service data requests using a plurality of workloads at each of a plurality of computing nodes in a manner that enables the workloads to respond directly to requesting external endpoints associated with the data requests. When DSR is used, for example, instead of a computing node responding to a request and providing the response to the load balancing node, which in turn provides the response to an external endpoint, the computing node servicing the request may directly provide the response to an external endpoint. In various embodiments, techniques disclosed herein reduce the likelihood of a load balancing node becoming a bottleneck, as responses are sent by servicing workloads directly to external endpoints that sent the data request. This approach reduces the number of data packets handled by the load balancing node, thereby reducing the likelihood that the load balancing node becomes a bottleneck for the cloud service, which improves the performance of a cloud service in handling data requests. In various embodiments, the load balancing node is configured to select a workload to service a request. The computing node is configured to receive and process a data packet comprising the request, including by selecting a workload to service the request from among a plurality of workloads on the computing node. In some embodiments, the workload selected by the computing node is the same workload selected by the load balancing node. In some embodiments, the workload selected by the computing node is different than the workload selected by the load balancing node.

An external endpoint sends a request to a cloud service and the request may be received at a load balancing node of the cloud service. The request may be comprised of a data packet. The data packet includes a destination internet protocol (IP) address and/or a destination port. The load balancing node may implement an analyzer, such as a Berkeley Packet Filter (BPF) to analyze the data packet. The analyzer performs a connection tracking lookup to determine whether the request has already been handled. In response to a determination that the request has been handled, the lookup may return a value indicating that the flow has been encapsulated along with the destination IP address. The analyzer may use this information to encapsulate the packet and provide the packet to the destination associated with the destination IP address. In response to a determination that the request has not been handled, the analyzer performs a lookup based on a tuple comprised of the destination IP address and/or the destination port included in the data packet. The lookup may return a value that indicates a workload identifier and a number of workloads having the workload identifier.

The analyzer selects one of the workloads having the workload identifier. The analyzer may determine whether the selected workload is local, i.e., on the load balancing node on which the analyzer is running or a different node associated with the cloud service. The workload having the workload identifier may be hosted on the load balancing node or one or more other computing nodes associated with the cloud service. In the event the selected workload is local, the data request is provided to the selected workload. In the event the selected workload is not local, i.e., on a different node associated with the cloud service, then the load balancing node performs a lookup using a routing map to determine an IP address associated with the computing node on which the selected workload is hosted. The load balancing node generates a connection tracking entry and store connection tracking information in a map. The connection tracking information may include information associated with the external endpoint and information associated with the selected workload. The load balancing node may encapsulate the data packet by applying an additional header (e.g., Virtual Extensible LAN (VXLAN)) to the data packet and provide the encapsulated packet to the computing node on which the selected workload is running. The additional header may include information such as a source identifier, a destination identifier, and a VXLAN network identifier (VNI).

The computing node hosting the selected workload may receive the encapsulated packet and analyze the received packet. The computing node may analyze a header associated with the received packet and determine to perform DSR load balancing based on a value included in the received packet (e.g., a VNI value). An analyzer running on the computing node may parse the additional header and an original header associated with the received packet to extract the destination IP address and/or the destination port associated with the received packet. The analyzer running on the computing node performs a lookup using a load balancing map. The load balancing map stored by the computing node may store information associated one or more workloads, but limited to the one or more workloads running on the computing node. The analyzer running on the computing node determines that one or more workloads hosted by the computing node are able to handle the request. The analyzer running on the computing node may select one of the one or more workloads hosted by the computing node to handle the request. The analyzer running on the computing node may decapsulate the received packet and provide the decapsulated packet to the selected workload. In some embodiments, the selected workload is the workload selected by the load balancing node. In some embodiments, the selected workload is different than the workload selected by the load balancing node.

The selected workload generates a response packet based on the data packet received from the analyzer running on the computing node. An analyzer running on the workload interface performs a connection tracking lookup to determine a destination for the response packet. The analyzer running on the workload identifies the connection tracking entry generated by the load balancing node and uses the connection tracking information included in the connection tracking entry to determine the destination (e.g., the external endpoint) for the response packet. The BPF running on the workload interface performs source network address translation on the response packet and directly provides the response packet to the external endpoint.

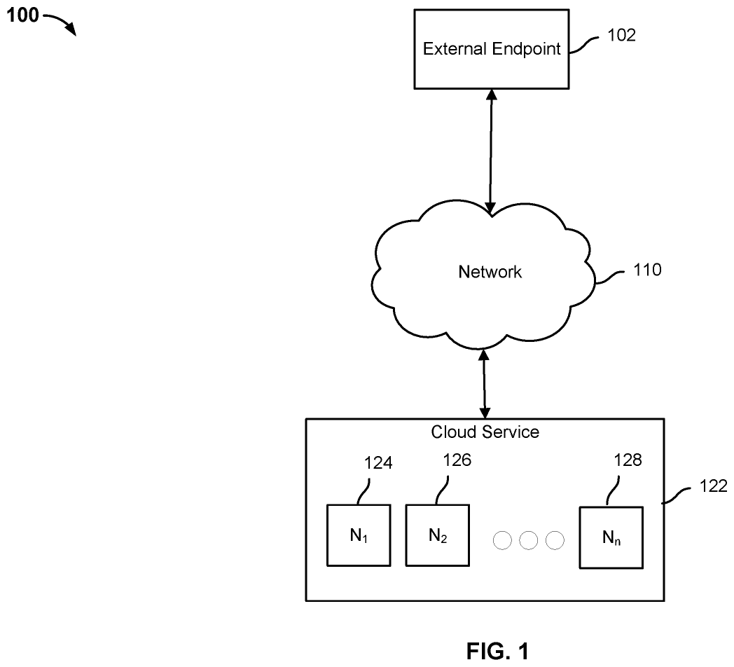

FIG. 1 is a block diagram illustrating an embodiment of a system for cloud service load balancing. In the example shown, system 100 is comprised of external endpoint 102, network 110, and cloud service 122.

External endpoint 102 may be a user device, such as a mobile phone, a smartphone, a laptop, a computer, a server, a tablet, or any other electronic device that is capable of sending and receiving data packets. External endpoint 102 sends a request to cloud service 122 via network 110. Network 110 may be a LAN, WAN, intranet, the Internet, and/or a combination thereof. The request is comprised of a data packet. The data packet may include a destination IP address and/or a destination port.

Cloud service 122 is comprised of computing nodes 124, 126, 128. Although three computing nodes are illustrated in FIG. 1, cloud service 122 may be comprised of n computing nodes where n is a number greater than zero. The request sent from external endpoint 102 is received at one of the computing nodes 124, 126, 128. In some embodiments, one of the computing nodes 124, 126, 128 is designated as a load balancing node for cloud service 122. In some embodiments, each of the computing nodes 124, 126, 128 may receive a request and act as a load balancing node for cloud service 122. Each of the computing nodes 124, 126, 128 have a corresponding processor, corresponding memory, and corresponding storage. Each of the computing nodes 124, 126, 128 may have a corresponding daemon that is configured to populate maps stored by a corresponding computing node.

The load balancing node implements an analyzer to analyze the data packet. The analyzer performs a connection tracking lookup to determine whether the request has already been handled. In response to a determination that the request has been handled, the lookup returns a value that indicating the flow has been encapsulated along with the destination IP address. The analyzer may use this information to encapsulate the packet and provide the packet to the destination associated with the destination IP address. In response to a determination that the request has not been handled, the analyzer performs a lookup based on a tuple comprised of the destination IP address and/or the destination port included in the data packet. The lookup may be performed using a map that is indexed on destination IP address and/or destination port. The lookup may return a value that is indicates a workload identifier and a number of workloads having the workload identifier. The value may be used to compute a workload lookup key. The workload lookup key may be used to look up details associated with one of the workloads to which the data packet is directed. In some embodiments, a computing node map is indexed on the original destination IP address of a packet. Each value that the computing node map includes contains the metadata for the service (e.g., type of service, number of workloads, ID of the workloads, etc.). A load balancing node may select a workload key by combining a randomly chosen index in the range [0, number of backends]. The load balancing node may then look up the workload key in the workload map. The returned value may include details associated with the particular workload, e.g., its IP address and the IP address of the computing node hosting the particular workload.

The analyzer of the load balancing node selects one of the workloads having the workload identifier. For example, computing node 124 may host one workload having the workload identifier, computing node 126 may host three workloads having the workload identifier, and computing node 128 may host five workloads having the workload identifier. In some embodiments, the selected workload is hosted on the load balancing node. In some embodiments, the selected workload is hosted on a different computing node of cloud service 122. The analyzer of the load balancing node may determine whether the selected workload is local, i.e., on the load balancing node on which the analyzer is running or a different node associated with the cloud service. In the event the selected workload is local, the request is provided to the selected workload. In the event the selected workload is not local, i.e., on a different node associated with the cloud service, then the load balancing node performs a lookup using a routing map to determine an IP address associated with the computing node on which the selected workload is hosted.

The load balancing node generates a connection tracking entry and stores connection tracking information in a map. The connection tracking information may include information associated with the external endpoint and information associated with the selected workload. The connection tracking map may be indexed on an IP address of the load balancing node, a port number associated with the load balancing node, an IP address of the computing node on which the selected workload is running, a port number associated with the computing node on which the selected workload is running, and an IP protocol associated with the data packet. The connection tracking map may also store other information, such as whether NAT has been performed with respect to the data packet and/or an IP address associated with a source of the data packet (e.g., IP address of external endpoint 102).

The load balancing node may encapsulate the data packet by applying an additional header (e.g., VXLAN) to the data packet and provide the encapsulated packet to the computing node on which the selected workload is hosted (e.g., computing node 124, computing node 126, or computing node 128). The additional header (e.g., a tunneling header) may include information such as a source identifier, a destination identifier, and a VNI. The VNI value may indicate that the computing node receiving the encapsulated data packets needs to perform DSR load balancing.

The computing node hosting the selected workload (e.g., computing node, computing node 126, or computing node 128) receives the encapsulated packet, analyzes the encapsulated packet, and determines to perform load balancing based on a VNI value included in a header of the encapsulated packet. The computing node receiving the packet subsequently selects a workload from one or more workloads hosted by the computing node and forward the data packet to the selected workload. In some embodiments, the computing node hosts a workload having a workload ID identified by the load balancing node and selects the workload. In some embodiments, the computing node hosts a plurality of workloads having the workload ID identified by the load balancing node and selects one of the workloads having the workload ID identified by the load balancing node.

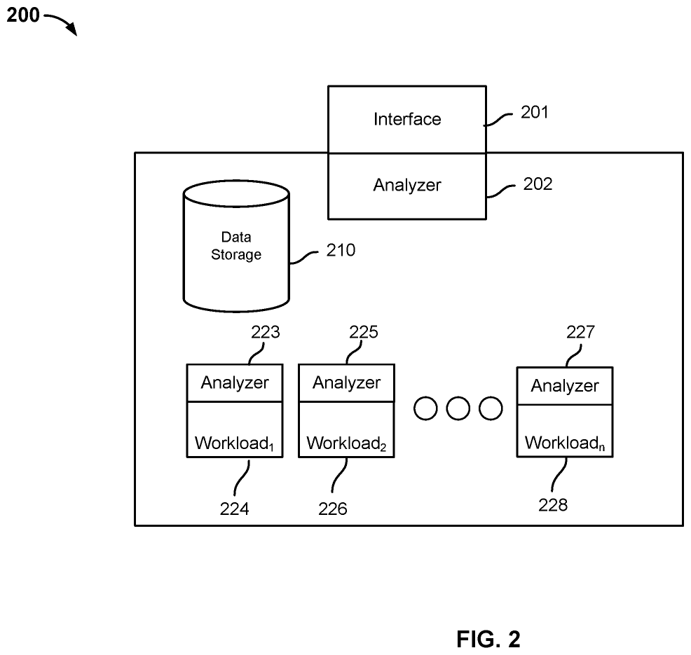

FIG. 2 is a block diagram illustrating an embodiment of a computing node. In the example shown, computing node may be implemented as a computing node, such as computing nodes 124, 126, 128.

Computing node 200 includes an interface 201 that is configured to receive one or more data packets. Interface 201 is coupled to analyzer 202 that is configured to analyze the one or more data packets received at interface 201. Computing node 200 hosts workloads 224, 226, 228. Although computing node 200 is shown having three workloads, computing node 200 may host n workloads. Each of the workloads 224, 226, 228 is associated with a corresponding analyzer 223, 225, 227, respectively. A workload may be a virtual machine, a container, a pod, etc.

Computing node 210 includes data storage 210. Data storage 210 may store information associated workloads, computing nodes, connection tracking, and routing. Data storage 210 may store a computing node map, a workload map, a connection tracking map, and a routing map. The computing node map may be indexed on destination IP address and/or destination port. The workload map may be indexed on workload ID and workload index. The connection tracking map may be indexed on load balancing node IP address, load balancing node port, computing node IP address, computing node IP address, and protocol. The connection tracking map may store two entries (forward entry, reverse entry) for each data request. The forward entry may store data about a flow and the reverse entry may store the key of the forward entry. To generate the key of the forward entry, a source IP address may be concatenated with a source port and a destination IP address may be concatenated with a destination port. The concatenated values may be sorted and a connection tracking key may be formed based on a lowest IP address/port value and a highest IP address/port value, and an originator of a flow is stored in the connection tracking value. Computing node 210 may include a daemon (not shown) that is configured to populate maps stored by data storage 210. The maps stored in the data storage of one computing node may be shared with other computing nodes.

In some embodiments, computing node 200 is a load balancing node. Analyzer 202 may perform a connection tracking lookup to determine whether the request has already been handled. In order to handle node ports, which may be exposed on multiple IP addresses, data storage 210 may store (<special value>, <node port>) for any node ports. Analyzer 202 may attempt a lookup using destination IP address and packet port, but if there is a miss and the destination IP address is local to node 200, analyzer 202 may instead perform a lookup using special value and node port to determine a destination for the data packet. In response to determining that the request has not been handled, analyzer 202 may perform a lookup based on a tuple comprised of the destination IP address and/or the destination port included in the data packet using a map stored in data storage 210. The lookup may return a value that is indicates a workload identifier and a number of workloads having the workload identifier. Analyzer 202 selects one of the workloads having the workload identifier. Analyzer 202 determines whether the selected workload is local or on a different node associated with the cloud service. The workload having the workload identifier may be hosted by the load balancing node or hosted by one or more other computing nodes associated with the cloud service. In the event the selected workload is local, the request is provided to the selected workload. In the event the selected workload is not local, i.e., on a different node associated with the cloud service, then the load balancing node performs a lookup using a routing map to determine an IP address associated with the computing node on which the selected workload is hosted. The load balancing node generates a connection tracking entry and stores connection tracking information in a map that is stored in data storage 210. The connection tracking information may include information associated with the external endpoint and information associated with the selected workload. The load balancing node may encapsulate the data packet by applying an additional header (e.g., VXLAN) to the data packet and provide the encapsulated packet to the computing node on which the selected workload is running. The additional header may include information such as a source identifier, a destination identifier, and a VNI.

In some embodiments, computing node 200 is a computing node that receives an encapsulated packet from a load balancing node via interface 201. Computing node 200 receives the encapsulated packet and analyzes the received packet. Computing node 200 may analyze a header associated with the received packet and determine to perform DSR load balancing based on a VNI value included in the received packet. Analyzer 202 may parse the additional header and an original header associated with the received packet to extract the destination IP address and/or destination port associated with the received packet. Analyzer 202 may perform a lookup using a load balancing map stored in data storage 210. The load balancing map stored by computing node 200 may store information associated one or more workloads, but is limited to the one or more workloads hosted on computing node 200. Analyzer 202 determines that one or more workloads hosted on computing node 200 that are able to handle the request. Analyzer 202 selects one of the one or more workloads hosted on computing node 202 to handle the request. In some embodiments, the selected workload is the workload selected by the load balancing node. In some embodiments, the selected workload is different than the workload selected by the load balancing node. Analyzer 202 decapsulates the received packet and provides the decapsulated packet to the selected workload. For example, the decapsulated packet may be provided to one of the workloads 224, 226, 228.

The selected workload generates a response packet based on the data packet received from analyzer 202. An analyzer running on the workload (e.g., analyzers 223, 225, 227) may perform a connection tracking lookup using the connection tracking map stored in data storage 210 to determine a destination for the response packet. The analyzer running on the workload interface may identify the connection tracking entry generated by the load balancing node and use the connection tracking information to determine the destination (e.g., the external endpoint) for the response packet. The analyzer running on the workload interface performs source network address translation on the response packet and directly provide the response packet to the external endpoint via interface 201.

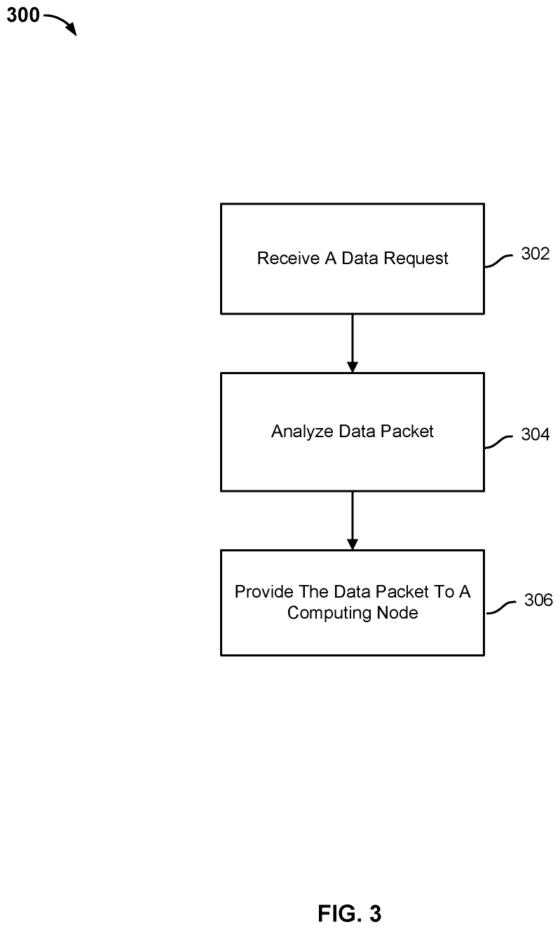

FIG. 3 is a flow chart illustrating an embodiment of a process for cloud service load balancing. In the example shown, process 300 may be implemented by a computing node, such as computing nodes 124, 126, 128.

At 302, a data request is received. The data request may be received from an external endpoint and be comprised of a data packet. The data packet may include information such as a destination IP address and/or a destination port.

At 304, the data packet is analyzed. A cloud service comprises a plurality of computing nodes. One of the plurality of computing nodes acts as a load balancing node. The cloud service may have a plurality of workloads that are able to handle the data request. The data packet may be analyzed to determine which workload associated with a cloud service is to handle the data request. For example, a first computing node of the cloud service may have one or more workloads that are able to handle the data request, a second node of the cloud service may have one or more workloads that are able to handle the data request, . . . , and an nth node of the cloud service may have one or more workloads that are able to handle the data request. The load balancing node selects one of the workloads.

At 306, the packet is provided to a computing node. The computing node may host a plurality of workloads that are able to handle the data request. The computing node may select one of the plurality of workloads that are able to handle the data request and provide the data request to the selected workload. In some embodiments, the selected workload is the workload selected by a load balancing node. In some embodiments, the selected workload is different than the workload selected by the load balancing node.

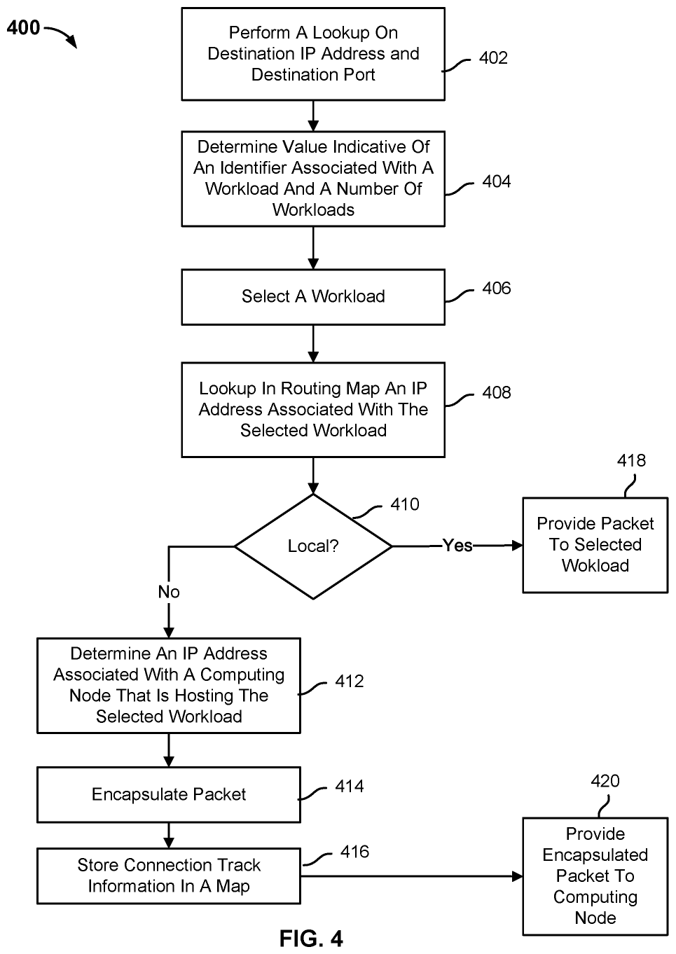

FIG. 4 is a flow chart illustrating an embodiment of a process for analyzing a data packet. In some embodiments, process 400 may be implemented to perform some or all of step 304 of process 300. In the example shown, process 400 may be implemented by a computing node, such as computing nodes 124, 126, 128.

At 402, a lookup using a destination IP address and/or a destination port is performed. A data packet is received by a load balancing node. The data packet may include information, such as the destination address and/or the destination port. A data storage of the load balancing node may store a map that associates destination IP address and/or destination port with a workload identifier and a number of workloads having the workload identifier.

At 404, a value indicative of an identifier associated with a workload and a number of workloads are determined. A map that associates destination IP address and/or destination port with a workload identifier and a number of workloads having the workload identifier may be used to determine the value indicative of an identifier associated with a workload and a number of workloads.

At 406, a workload is selected. There may be a plurality of workloads having the workload identifier. In some embodiments, the selected workload is hosted on the load balancing node. In some embodiments, the selected workload is hosted on a different computing node. In some embodiments, the different computing node is configured to host one or more workloads having the workload identifier. In some embodiments, the workload is randomly selected. In some embodiments, a workload is selected in a round-robin fashion. In some embodiments, a workload is selected based on resource availability of the workload. In some embodiments, the workload is selected by hashing the metadata of the packet. In some embodiments, a workload is selected using a weighted random allocation algorithm. For example, a user may select to send 1% of traffic to a new version of the cloud service to see how the new version performs.

At 408, an IP address associated with the selected workload is looked up in a routing map. The load balancing node may include a data store that includes a routing map that associates workloads with their corresponding IP addresses.

At 410, it is determined whether the selected workload is local to the load balancing node. In the event it is determined that the selected backend is local to the load balancing node, process 400 proceeds to 418. In the event it is determined that the selected backend is not local to the load balancing node, process 400 proceeds to 412.

At 412, an IP address associated a computing node that is hosting the selected workload is determined. The routing map may be stored in a data store of the load balancing node. The routing map may include entries that associate computing nodes with their corresponding IP addresses. In some embodiments, NAT maps and routing maps are combined. For example, a per-host daemon may combine the routing map and the workload map so that the routing information of the workload is included. In some embodiments, the node and workload maps are combined. In some embodiments, the first n workloads are stored in the node map. In the event the cloud service has fewer than n workloads, the workload metadata may be retrieved from the node map value rather than requiring a second lookup of the workload map.

At 414, the packet is encapsulated. The load balancing node may encapsulate the data packet by applying an additional header (e.g., VXLAN) to the data packet and provide the encapsulated packet to the computing node on which the selected workload is running. The additional header may be a tunneling header and include information such as a source identifier, a destination identifier, and VNI. In some embodiments, step 414 is optional. Instead, a destination L2 (layer 2) MAC address may be set to a MAC address associated with the computing node that is hosting the selected workload.

At 416, connection track information is stored in a map. A data store of the load balancing node may store a connection track map that includes one or more entries for connection track information. The connection tracking information may include information associated with the external endpoint and information associated with the selected workload. The load balancing node may share the connection track map with the other computing nodes of the cloud service.

At 418, the data packet is provided to the selected workload.

At 420, the encapsulated packet is provided to a computing node hosting the selected workload.

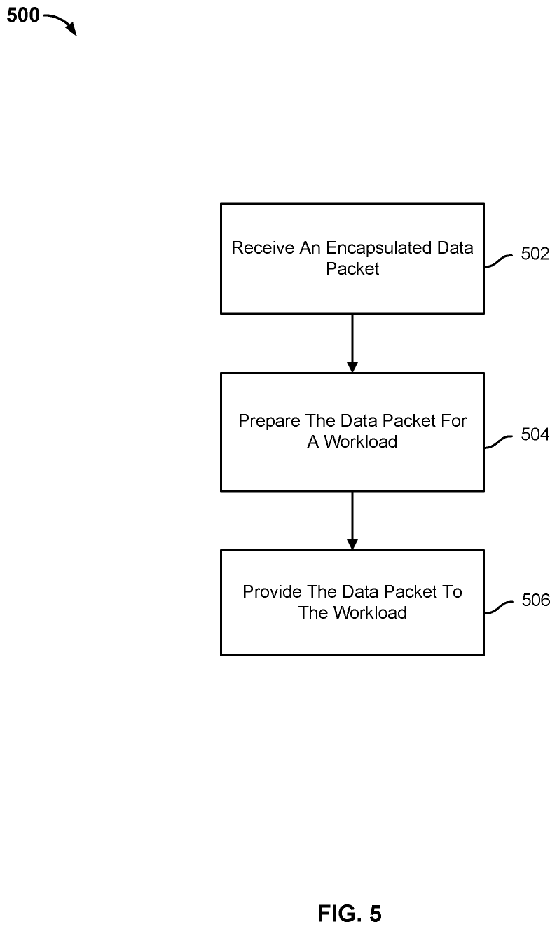

FIG. 5 is a flow chart illustrating an embodiment of a process for cloud service load balancing. In the example shown, process 500 may be implemented by a computing node, such as computing nodes 124, 126, 128.

At 502, an encapsulated data packet is received. The data packet may have been encapsulated by a load balancing node associated with a cloud service.

At 504, the data packet is prepared for a workload. A computing node may prepare the data packet for the workload at least in part by analyzing a header associated with the received packet and determining to perform DSR load balancing based on a VNI value included in the received packet. The computing node may include an analyzer that is configured to parse the additional header and an original header associated with the data packet to extract the destination IP address and/or destination port associated with the data packet. In some embodiments, the data packet is not encapsulated and a source L2 MAC address is used to determine that the packet needs to be locally load balanced with DSR treatment. The analyzer may determine that load balancing is to be performed by examining the source L2 MAC address to determine that the data packet was sent from another node. The analyzer may perform a lookup using a load balancing map. The load balancing map stored by the computing node may store information associated one or more workloads, but limited to the one or more workloads running on the computing node. The analyzer running on the computing node may determine that one or more workloads running on the computing node are able to handle the request. In some embodiments, the computing node may include a plurality of workloads hosted by the computing node that are able to handle the request. The analyzer may select one of the plurality of workloads hosted by the computing node that are able to handle the request. In some embodiments, the selected workload is the workload selected by a load balancing node. In some embodiments, the selected workload is different than the workload selected by the load balancing node. The analyzer decapsulates the encapsulated data packet and performs destination network address translation (DNAT) on the decapsulated packet so that the workload IP address is the destination IP address. In some embodiments, a workload is configured to expect packets to the original IP address. In which case, the DNAT (part of step 504) and SNAT steps (step 606) may be omitted.

At 506, the data packet is provided to the workload.

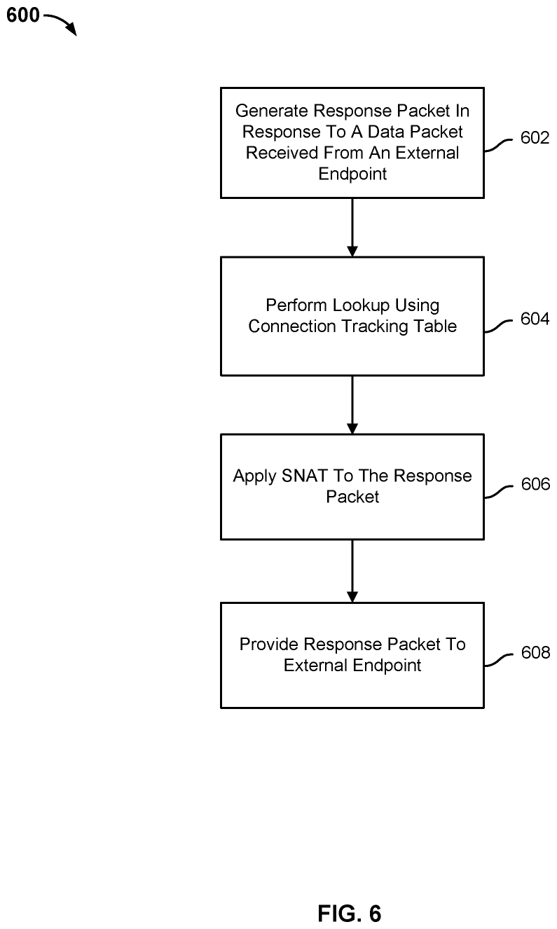

FIG. 6 is a flow chart illustrating an embodiment of a process for responding to a cloud service request. In the example shown, process 600 may be implemented by a workload, such as workloads 224, 226, 228.

At 602, a response packet is generated in response to a data packet received from an external endpoint. At 604, a lookup using a connection tracking table is performed. An analyzer running on a workload may perform a connection tracking lookup to determine a destination for the response packet. The analyzer running on the workload interface may identify the connection tracking entry generated by the load balancing node and use the connection tracking information to determine the destination (e.g., the external endpoint) for the response packet. In some embodiments, the connection information is attached to the computing node kernel's existing socket tracking table.

At 606, source network address translation (SNAT) is applied to the received packet.

At 608, the response packet is provided from the computing node hosting the workload to an external endpoint. This may improve a performance of a cloud service because instead of providing to the load balancing node the response packet, the workload may directly provide the response packet to the external endpoint. This reduces the number of data packets handled by the load balancing node and reduces the likelihood that the load balancing node becomes a bottleneck for the cloud service.

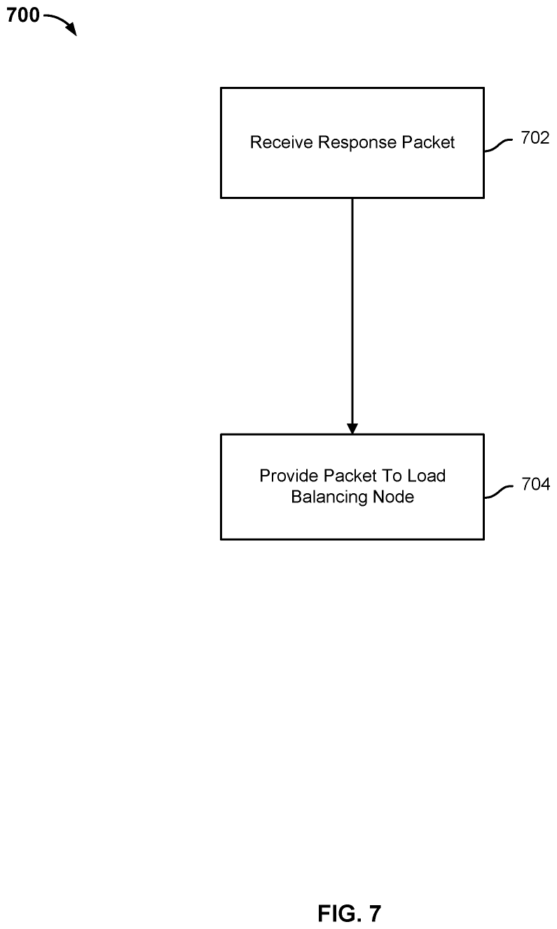

FIG. 7 is a flow chart illustrating an embodiment of a process for responding to a cloud service request. In the example shown, process 700 may be implemented by a workload, such as workloads 224, 226, 228.

At 702, a response packet is received. The response packet may be received from a workload hosted by a computing node. The workload may use its own IP address for the source IP address and the original client IP address as the destination IP address. The node hosting the workload may perform a SNAT to swap the workload's IP address for the original destination IP address (i.e., the IP address of the original load balancing node, as looked up in the connection tracking table). The response packet may be encapsulated.

At 704, the packet is provided to a load balancing node. The load balancing node may subsequently provide the packet to an endpoint. In some embodiments, the load balancing node decapsulates the encapsulated response packet and provides the decapsulated packet to an endpoint that generated the data request.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
analyzing, at a load balancing node of a cloud service, a data packet associated with a data request, wherein the cloud service comprises a plurality of computing nodes;
selecting a computing node included in the plurality of computing nodes to service the data request, based at least in part on a determination via said analyzing that the selected computing node is associated with a workload associated with the data request; and
providing the data packet associated with the data request to the selected computing node, wherein the computing node selects a workload from one or more workloads hosted by the computing node to handle the data request.

2. The method of claim 1, further comprising receiving the data packet associated with the data request.

3. The method of claim 1, wherein the load balancing node uses a Berkeley Packet Filter to analyze the data packet associated with the data request.

4. The method of claim 1, wherein the data packet associated with the data request includes a destination internet protocol address and/or a destination port.

5. The method of claim 4, wherein analyzing the data packet associated with the data request comprises performing a lookup on the destination internet protocol address and/or the destination port.

6. The method of claim 5, wherein analyzing the data packet associated with the data request further comprises determining a value indicative of an identifier associated with a workload and a number of workloads having the identifier.

7. The method of claim 6, wherein analyzing the data packet associated with the data request further comprises selecting one of the workloads having the identifier.

8. The method of claim 7, wherein an internet protocol address associated with a computing node hosting the selected workload is stored in a network address translation map associated with a plurality of workloads.

9. The method of claim 7, wherein analyzing the data packet associated with the data request further comprises determining that the selected workload is located on the computing node that is different than the load balancing node.

10. The method of claim 9, wherein analyzing the data packet associated with the data request further comprises determining an internet protocol address associated with the computing node.

11. The method of claim 10, wherein analyzing the data packet associated with the data request further comprises storing connection track information.

12. The method of claim 10, wherein analyzing the data packet associated with the data request further comprises encapsulating the data packet with an additional header.

13. The method of claim 12, wherein the encapsulated data packet includes a value that indicates the computing node needs to perform load balancing.

14. The method of claim 10, wherein a destination layer 2 MAC address is set to a MAC address associated with the computing node hosting the selected workload and the data packet is provided to the computing node hosting the selected workload, wherein the computing node hosting the selected workload performs load balancing on the data packet.

15. The method of claim 1, wherein the data packet provided to the computing node is encapsulated, wherein the computing node decapsulates the encapsulated data packet.

16. The method of claim 15, wherein the computing node performs destination network address translation on the data packet and provides the data packet to the selected workload.

17. The method of claim 16, wherein the selected workload generates a response packet, wherein source network address translation is applied to the response packet, wherein the response packet is encapsulated and provided to the load balancing node.

18. The method of claim 17, wherein the load balancing node decapsulates the encapsulated response packet and provides the decapsulated packet to an endpoint that generated the data request.

19. The method of claim 16, wherein the selected workload generates a response packet, wherein source network address translation is applied to the response packet.

20. The method of claim 19, wherein the response packet is provided from the computing node hosting the selecting workload to an endpoint that generated the data request.

21. A system, comprising:
a processor configured to:
analyze, at a load balancing node of a cloud service, a data packet associated with a data request, wherein the cloud service comprises a plurality of computing nodes;
select a computing node included in the plurality of computing nodes to service the data request, based at least in part on a determination via an analysis that the selected computing node is associated with a workload associated with the data request; and
provide the data packet associated with the data request to the selected computing node, wherein the computing node selects a workload from one or more workloads hosted by the computing node to handle the data request; and
a memory coupled to the processor and configured to provide the processor with instructions.

22. A computer program product, the computer program product being embodied in a non-transitory computer readable storage medium and comprising computer instructions for:
analyzing, at a load balancing node of a cloud service, a data packet associated with a data request, wherein the cloud service comprises a plurality of computing nodes;
selecting a computing node included in the plurality of computing nodes to service the data request, based at least in part on a determination via said analyzing that the selected computing node is associated with a workload associated with the data request; and
providing the data packet associated with the data request to the selected computing node, wherein the computing node selects a workload from one or more workloads hosted by the computing node to handle the data request.
